(19) United States
(12) Patent Application Publication
(10) Pub. No.: US 2025/0293467 A1
(43) Pub. Date: Sep. 18, 2025

(54) USB TYPE B CONNECTOR, TRANSMISSION LINE, AND ELECTRONIC DEVICE

(71) Applicant: Wistron Corporation, New Taipei City (TW)

(72) Inventors: Lung Fai Tuen, New Taipei City (TW); Chih Long Chou, New Taipei City (TW)

(73) Assignee: Wistron Corporation, New Taipei City (TW)

(21) Appl. No.: 18/754,167

(22) Filed: Jun. 26, 2024

(30) Foreign Application Priority Data
Mar. 18, 2024 (TW) 113110017

(51) Int. Cl. H01R 13/66; G06F 13/38; H01R 13/6471

(52) U.S. Cl. CPC H01R 13/6691; G06F 13/385; H01R 13/6471; G06F 2213/0042

(57) ABSTRACT

A USB type B connector includes a row of first terminals, a row of second terminals, and a ground metal layer. The row of second terminals is located below the row of first terminals, and each terminal of the row of second terminals extends along a first axis. The ground metal layer is located between the row of first terminals and the row of second terminals. A length of the ground metal layer on the first axis is greater than or equal to a length of each terminal of the row of first terminals on the first axis and a length of each terminal of the row of second terminals on the first axis. A transmission line and an electronic device including the USB type B connector are also provided.

### CROSS-REFERENCE TO RELATED APPLICATION

This application claims the priority benefit of Taiwan application serial no. 113110017, filed on Mar. 18, 2024. The entirety of the above-mentioned patent application is hereby incorporated by reference herein and made a part of this specification.

### BACKGROUND

### Technical Field

The invention relates to a USB type B connector, a transmission line, and an electronic device, and particularly relates to a USB type B connector, a transmission line, and an electronic device that are able to avoid external interference or/and does not affect signal transmission and reception of other connectors during signal transmission and reception.

### Description of Related Art

At present, USB type B connectors are quite common, along with advancement of technology, how to avoid external interference or avoid affecting signal transmission and reception of other connectors during signal transmission and reception is a research direction in this field.

### SUMMARY

The invention is directed to a USB type B connector, which is adapted to avoid external interference or avoid affecting signal transmission and reception of other connectors during signal transmission and reception.

The invention is directed to a transmission line and an electronic device, which has the aforementioned USB type B connector.

The invention provides a USB type B connector including a row of first terminals, a row of second terminals, and a ground metal layer. The row of second terminals is located below the row of first terminals, and each terminal of the row of second terminals extends along a first axis. The ground metal layer is located between the row of first terminals and the row of second terminals. A length of the ground metal layer on the first axis is greater than or equal to a length of each terminal of the row of first terminals on the first axis and a length of each terminal of the row of second terminals on the first axis.

In an embodiment of the invention, projections of the row of first terminals and the row of second terminals on a plane where the ground metal layer is located are all within the ground metal layer.

In an embodiment of the invention, the USB type B connector further includes a casing and an insulating inner base located in the casing. A first socket is located between a casing top surface of the casing and an inner base top surface of the insulating inner base. The insulating inner base includes a second socket. The row of first terminals is located in the first socket. The row of second terminals is located in the second socket. The ground metal layer is located between the first socket and the second socket.

In an embodiment of the invention, the row of first terminals and the row of second terminals are arranged along a second axis, a material of the casing is a conductor, and the ground metal layer contacts the casing on the second axis.

In an embodiment of the invention, the insulating inner base includes an upper inner base and a lower inner base. The upper inner base includes the inner base top surface. The lower inner base includes a second socket. A third socket is located between the upper inner base and the lower inner base, and the ground metal layer is located in the third socket.

In an embodiment of the invention, the ground metal layer is a rectangular metal sheet, and two opposite outer edges of the ground metal layer contact the casing.

In an embodiment of the invention, the ground metal layer includes a main body metal sheet and two extension parts extending from the main body metal sheet, and the two extension parts contact the casing.

In an embodiment of the invention, the row of first terminals and the row of second terminals are arranged along a second axis. The main body metal sheet includes a first part and a second part. The two extension parts are two elastic arms that contact an inner surface of the casing. The two elastic arms are located on two sides of the first part, and a distance between two outer edges of the two elastic arms on the second axis is greater than a length of the second part on the second axis.

In an embodiment of the invention, each of the two elastic arms includes a fixed end away from the second part and a free end close to the second part. There is a gap between the free end and the first part.

In an embodiment of the invention, the two extension parts contact an outer surface of the casing.

In an embodiment of the invention, the insulating inner base includes at least one spacing rib located in the third socket. The at least one spacing rib divides the third socket into a plurality of sub-sockets. The ground metal layer includes a plurality of metal bars connected with each other, and the metal bars are respectively located in the sub-sockets.

In an embodiment of the invention, the row of first terminals and the row of second terminals are arranged along a second axis. The at least one spacing rib includes two spacing ribs. The plurality of sub-sockets include three sub-sockets arranged along the second axis. The metal bars include three metal bars, and lengths of the three metal bars on the second axis respectively correspond to lengths of the three sub-sockets on the second axis.

In an embodiment of the invention, the length of a central one of the three metal bars on the second axis is less than the length of any of the other two of the three metal bars on the second axis.

In an embodiment of the invention, two of the three metal bars located on two sides contact the casing.

In an embodiment of the invention, the insulating inner base includes an upper inner base and a lower inner base. The upper inner base includes an inner base top surface, and the lower inner base includes a second socket. The casing is made of metal, and the casing includes a ground metal layer and a first cavity and a second cavity separated by the ground metal layer. The upper inner base is located in the first cavity, and the lower inner base is located in the second cavity.

In an embodiment of the invention, the casing includes an upper casing base and a lower casing base. The ground metal layer includes a first layer and a second layer that are bent and folded. The first layer is connected to the upper casing base, the second layer is connected to the lower casing base, and the ground metal layer, the upper casing base, and the lower casing base are integrated.

The invention provides a transmission line including a wire and the above-mentioned USB type B connector, connected to the wire.

In an embodiment of the invention, the ground metal layer is electrically connected to the wire.

The invention provides an electronic device including a first connector and a second connector. The first connector is the aforementioned USB type B connector. The second connector is located next to the first connector.

In an embodiment of the invention, the second connector is different from the first connector, or the second connector is the same as the first connector.

Based on the above descriptions, in the USB type B connector of the invention, the ground metal layer is disposed between the row of first terminals and the row of second terminals, and the length of the ground metal layer on the first axis along which the second terminals extend is greater than or equal to the length of each terminal of the row of first terminals on the first axis and the length of each terminal of the row of second terminals on the first axis. Such design may have at least the following two functions during signal transmission and reception, first, it brings the impedance matching back to an original control range to enhance resistance to external interference, thereby providing good signal stability, second, it has a good shielding effect and reduces impact on signal transmission and reception of other surrounding connectors.

### BRIEF DESCRIPTION OF THE DRAWINGS

FIG. 1 is a partial schematic diagram of a transmission line according to an embodiment of the invention.

FIG. 2 is a schematic front view of a connector of FIG. 1.

FIG. 3A is a schematic diagram of a ground metal layer of the connector of FIG. 1 before assembly.

FIG. 3B is a schematic partial cross-sectional view along a line A-A of FIG. 3A.

FIG. 3C is a schematic partial cross-sectional view along a line B-B of FIG. 3A.

FIG. 4 is a schematic diagram of a ground metal layer of a connector before assembly according to another embodiment of the invention.

FIG. 5 is a schematic diagram of the ground metal layer of FIG. 4.

FIG. 6 is a schematic front view of a connector according to another embodiment of the invention.

FIG. 7 is a schematic diagram of a connector according to another embodiment of the invention.

FIG. 8 is a schematic diagram of a ground metal layer of the connector of FIG. 7 before assembly.

FIG. 9 is an RFI test result diagram of interference signal received by other adjacent connectors when a conventional USB 3.0 type B connector is in operation.

FIG. 10 is an RFI test result diagram of interference signal received by other adjacent connectors when the connector of FIG. 7 is in operation.

FIG. 11 is a schematic diagram of a connector according to another embodiment of the invention.

FIG. 12 to FIG. 13 are schematic diagrams of a connector from different perspectives according to another embodiment of the invention.

FIG. 14 is a schematic diagram of an electronic device according to an embodiment of the invention.

### DESCRIPTION OF THE EMBODIMENTS

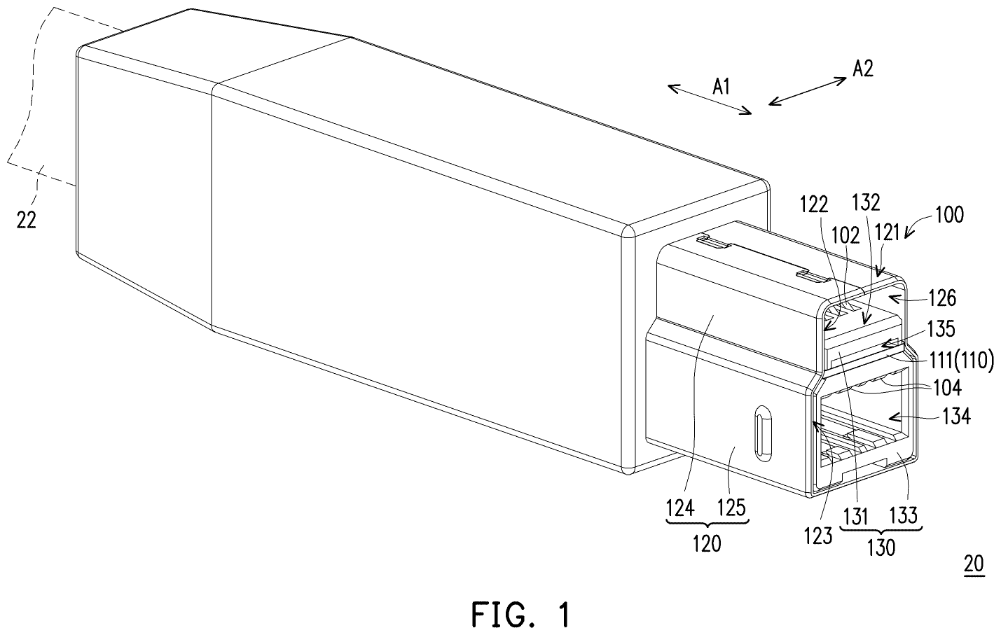

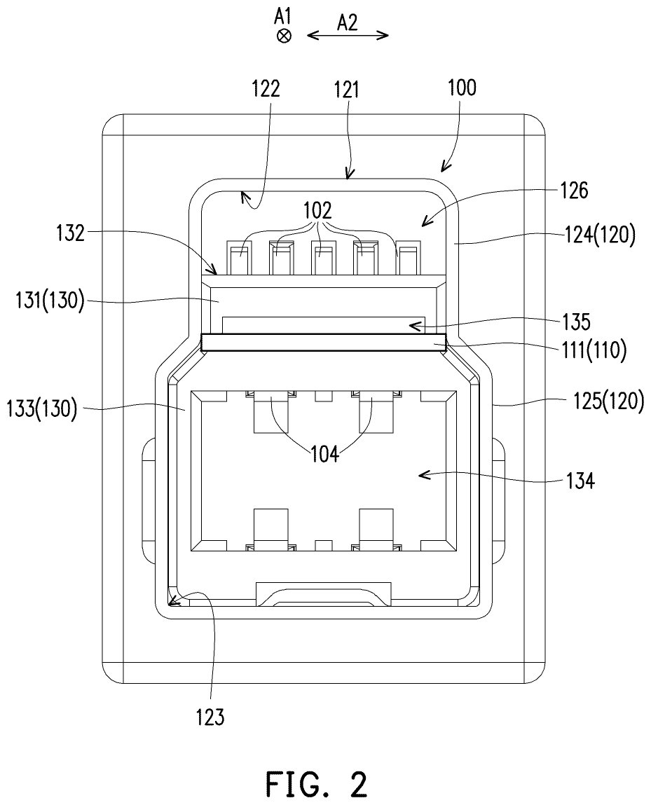

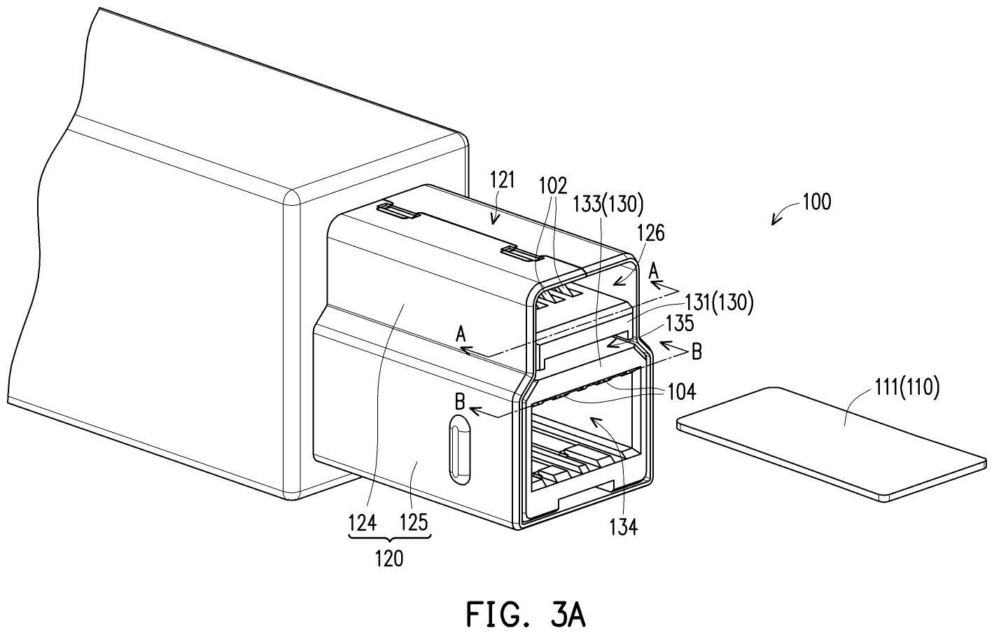

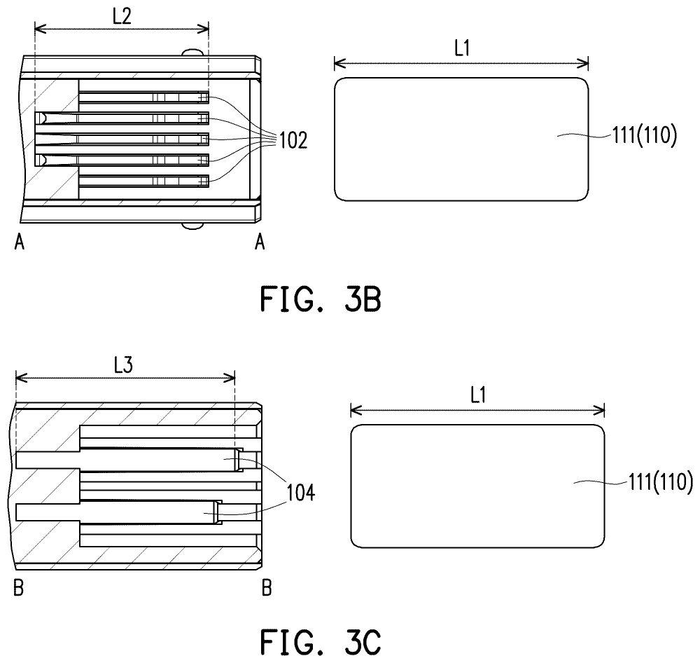

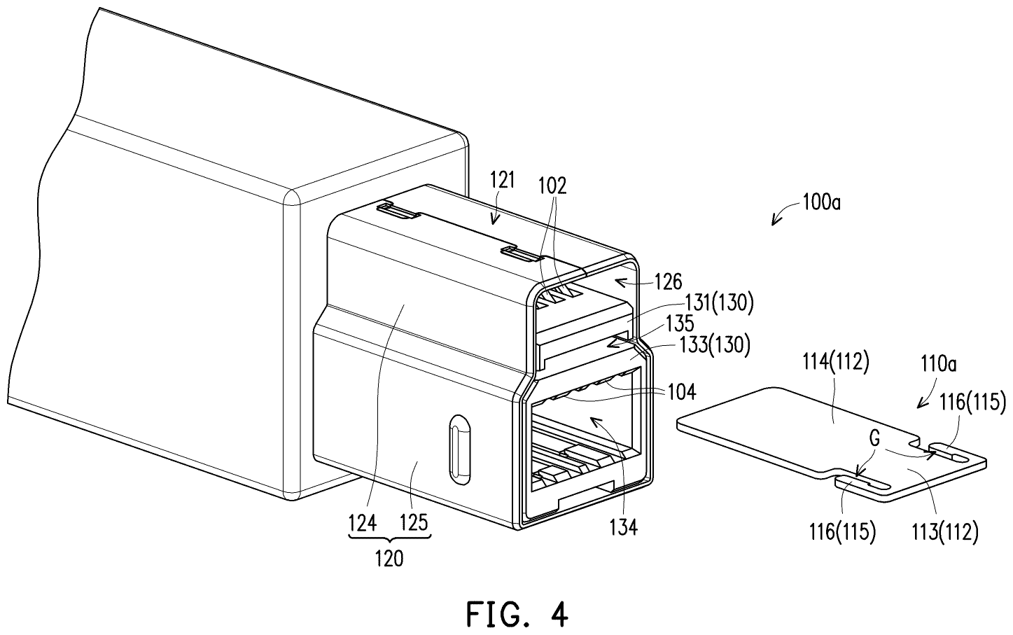

FIG. 1 is a partial schematic diagram of a transmission line according to an embodiment of the invention. FIG. 2 is a schematic front view of a connector of FIG. 1. FIG. 3A is a schematic diagram of a ground metal layer of the connector of FIG. 1 before assembly.

Referring to FIG. 1 to FIG. 3A, a transmission line 20 of the embodiment includes a wire 22 and a USB type B connector 100 connected to the wire 22. The USB type B connector 100 in the embodiment is, for example, a male connector, but the USB type B connector may also be a female connector, which is not limited by the invention. The USB type B connector 100 is, for example, a USB 3.2 or above connector, but the invention is not limited thereto.

The USB type B connector 100 includes a row of first terminals 102, a row of second terminals 104, and a ground metal layer 110. The row of second terminals 104 is located below the row of first terminals 102. The first terminals 102 and the second terminals 104 extend along a first axis A1. The ground metal layer 110 is located between the row of first terminals 102 and the row of second terminals 104.

It should be noted that, as shown in FIG. 2, the USB type B connector 100 of the embodiment has three rows of terminals, the first terminals 102 are terminals in the uppermost row, the second terminals 104 are terminals in a middle row, and there is a row of terminals below the second terminals 104. Certainly, in other embodiments, the number of rows of terminals and the positions of the first terminals 102 and the second terminals 104 are not limited thereto.

In the embodiment, the first terminals 102 are, for example, signal terminals or ground terminals, and the second terminals 104, for example, include a power supply terminal, a ground terminal or/and a signal terminal. Certainly, the types of the first terminals 102 and the second terminals 104 are not limited thereto. In addition, in the row of first terminals 102, the terminals may have the same or different types. In the row of second terminals 104, the terminals may also have the same or different types.

FIG. 3B is a schematic partial cross-sectional view along a line A-A of FIG. 3A. FIG. 3C is a schematic partial cross-sectional view along a line B-B of FIG. 3A. Referring to FIG. 3B, a length L1 of the ground metal layer 110 on the first axis A1 (indicated in FIG. 1, which is a left-right direction of FIG. 3B) is greater than or equal to a length L2 of each terminal of the row of first terminals 102 on the first axis A1. Referring to FIG. 3C, the length L1 of the ground metal layer 110 on the first axis A1 is greater than or equal to a length L3 of each terminal of the row of second terminals 104 on the first axis A1.

Since the ground metal layer 110 is located between the row of first terminals 102 and the row of second terminals 104, projections of the row of first terminals 102 and the row of second terminals 104 on the plane where the ground metal layer 110 is located are all located within the ground metal layer 110. Such a design may have at least the following two functions during signal transmission and reception: first, it brings the impedance matching back to an original control range to enhance resistance to external interference, thereby providing good signal stability, second, it has a good shielding effect and reduces impact on signal transmission and reception of other surrounding connectors.

It should be noted that different types of connectors may have their originally defined specific impedance matching values. Taking USB as an example, under the original definition, the impedance matching value should be within a range of plus or minus 20 of 90 ohms. Certainly, the impedance matching value is not limited to this.

A ground plane of the conventional USB 3.0 type B connector is a metal casing. Since the metal casing is relatively far away from each terminal, it is unstable and easy to generate radiation. In the embodiment, the ground metal layer 110 located between the first terminals 102 and the second terminals 104 is added to the connector. Since the ground metal layer 110 is close to the first terminals 102 and the second terminals 104, such a design may make the circuit more stable, less likely to cause interference, and have better shielding effect.

Referring back to FIG. 1, the USB type B connector 100 further includes a casing 120 and an insulating inner base 130 located in the casing 120. The casing 120 includes an upper casing base 124, a lower casing base 125, a first cavity 122 surrounded by the upper casing base 124, and a second cavity 123 surrounded by the lower casing base 125. A first socket 126 is located between a casing top surface 121 of the upper casing base 124 and an inner base top surface 132 of the insulating inner base 130.

The insulating inner base 130 includes an upper inner base 131 and a lower inner base 133. The upper inner base 131 is located in the first cavity 122, and the lower inner base 133 is located in the second cavity 123. The upper inner base 131 includes the inner base top surface 132. The lower inner base 133 includes a second socket 134, a third socket 135 is located between the upper inner base 131 and the lower inner base 133.

The first terminals 102 are located in the first socket 126, and the second terminals 104 are located in the second socket 134. The row of first terminals 102 and the row of second terminals 104 are arranged along a second axis A2. The ground metal layer 110 is located in the third socket 135 between the first socket 126 and the second socket 134.

In the embodiment, the casing 120 is made of a conductor, such as metal, to serve as a part of a ground plane. The ground metal layer 110 contacts the casing 120 on the second axis A2 to connect to a larger ground plane to improve impedance stability. In an embodiment, the casing 120 may also be a non-conductor, such as plastic, and the ground metal layer 110 may also be electrically connected to the wire 22.

In an embodiment, the length L1 of the ground metal layer 110 on the first axis A1 may be greater than or equal to a length of the casing 120 to connect to a ground wire in the wire 22, but in other embodiments, the length of the ground metal layer 110 is not limited thereto, and the wire 22 may also be extended into the casing 120 to be connected to the ground metal layer 110. Alternatively, the ground metal layer 110 may only contact the casing 120, and the casing 120 may selectively contact the ground wire of the wire 22, and the configuration relationship is not limited to the above.

In addition, in the embodiment, the ground metal layer 110 is a rectangular metal sheet 111, and two opposite outer edges of the ground metal layer 110 contact the casing 120. Certainly, the form of the ground metal layer 110 is not limited thereto.

Other forms of connectors are introduced below. In the following embodiment, the same or similar elements as those in the previous embodiment are denoted by the same or similar symbols, details thereof are not repeated, and only main differences will be explained.

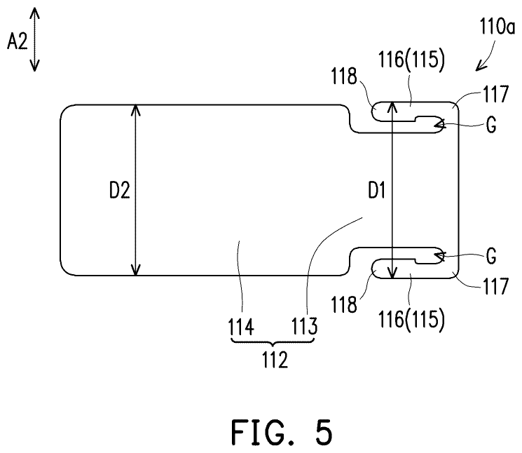

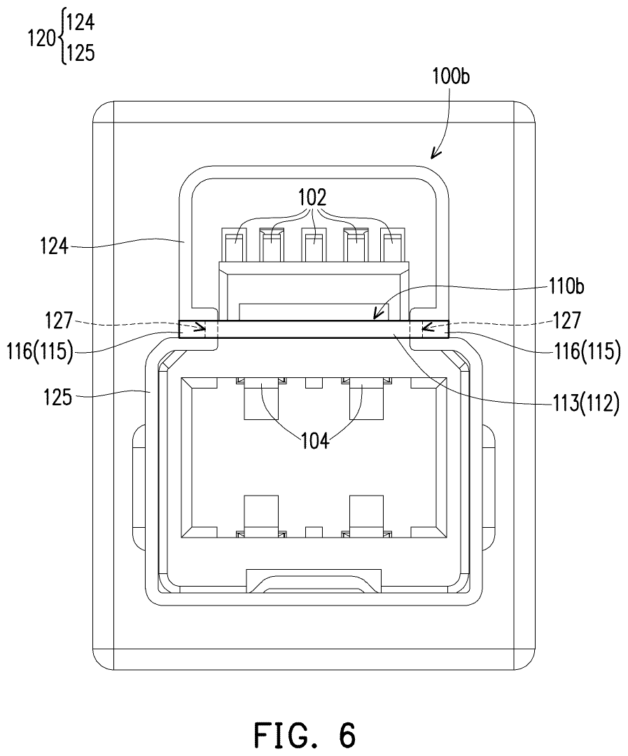

FIG. 4 is a schematic diagram of a ground metal layer of a connector before assembly according to another embodiment of the invention. FIG. 5 is a schematic diagram of the ground metal layer of FIG. 4. Refer to FIG. 4 and FIG. 5, a main difference between a USB type B connector 100a of the embodiment and the USB type B connector 100 of FIG. 1 lies in shapes of the ground metal layers 110 and 110a. In the embodiment, the ground metal layer 110a includes a main body metal sheet 112 and two extension parts 115 extending from the main body metal sheet 112, and the two extension parts 115 contact the casing 120, especially contact an inner surface of the casing 120 to connect to a larger ground plane to improve impedance stability.

As shown in FIG. 5, the main body metal sheet 112 includes a first part 113 and a second part 114. The two extension parts 115 are two elastic arms 116. The two elastic arms 116 are located on both sides of the first part 113. A distance D1 between two outer edges of the two elastic arms 116 on the second axis A2 is greater than a length D2 of the second part 114 on the second axis A2.

Each of the two elastic arms 116 includes a fixed end 117 away from the second part 114 and a free end 118 close to the second part 114. There is a gap G between the free end 118 and the first part 113. The distance D1 between the two outer edges of the elastic arms 116 on the second axis A2 may be equal to or slightly greater than a size of the third socket 135 on the second axis A2. The gap G may provide a space for the elastic arms 116 to retract when being squeezed by the inner surface of the casing 120, so as to ensure that the two extension parts 115 may surely abut against the inner surface of the casing 120.

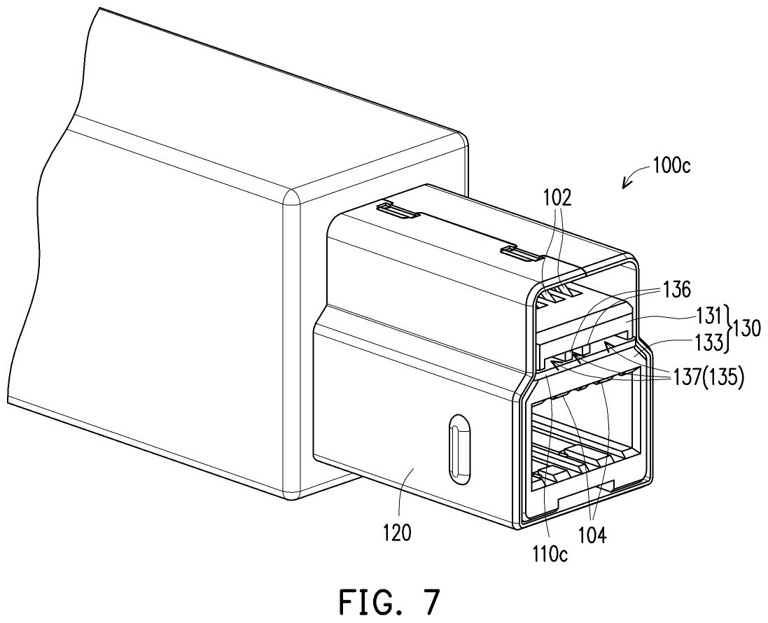

FIG. 6 is a schematic front view of a connector according to another embodiment of the invention. Referring to FIG. 6, a main difference between a USB type B connector 100b of the embodiment and the USB type B connector 100a of FIG. 4 is that in the embodiment, the casing 120b has two inner recesses 127 corresponding to the two extension parts 115, the two extension parts 115 of the ground metal layer 110b may extend into the two inner recesses 127 and contact an outer surface of the casing 120b to connect to a larger ground plane to improve impedance stability.

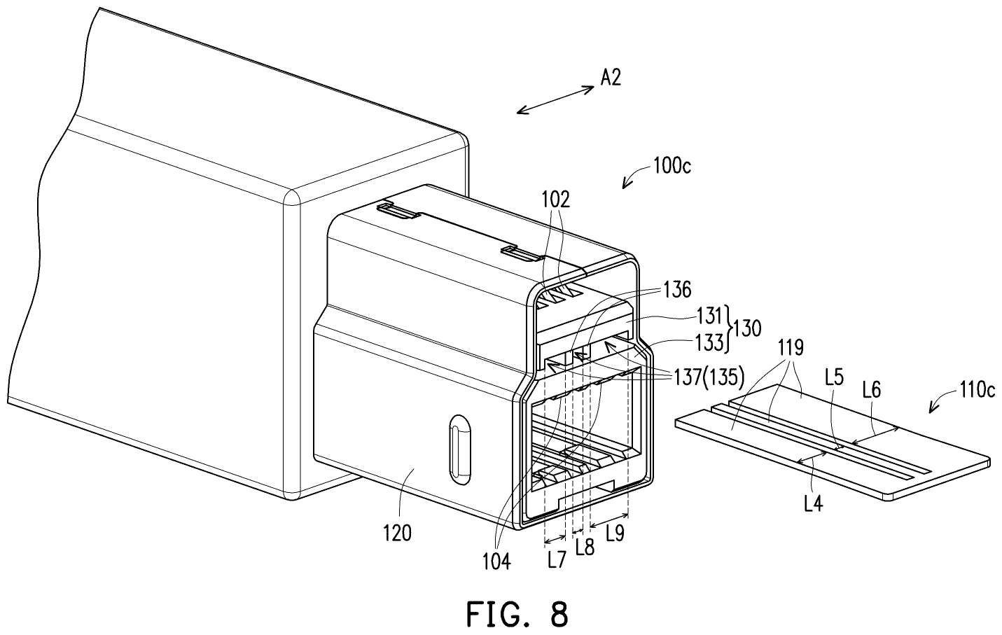

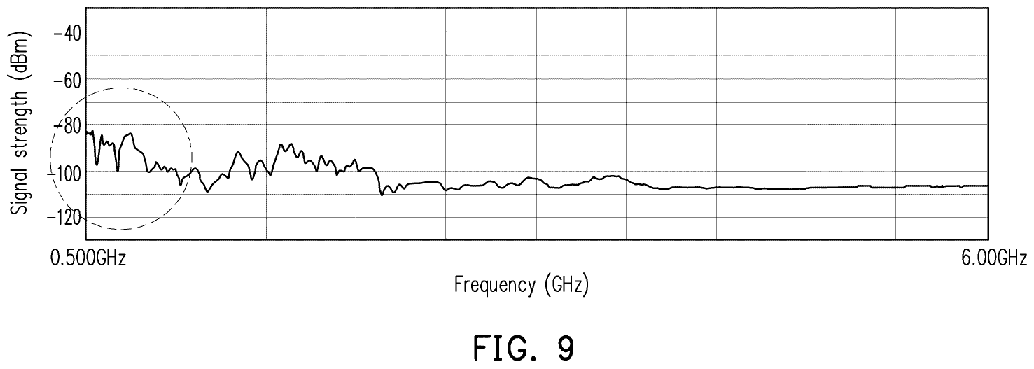

FIG. 7 is a schematic diagram of a connector according to another embodiment of the invention. FIG. 8 is a schematic diagram of a ground metal layer of the connector of FIG. 7 before assembly. Referring to FIG. 7 and FIG. 8, a main difference between a USB type B connector 100c of the embodiment and the USB type B connector 100 of FIG. 1 lies in a shape of the third socket 135 and a shape of the ground metal layer 110c. In the embodiment, the insulating inner base 130 includes at least one spacing rib 136 located in the third socket 135, and the at least one spacing rib 136 divides the third socket 135 into a plurality of sub-sockets 137. As shown in FIG. 8, the ground metal layer 110c includes a plurality of connected metal bars 119, and these metal bars 119 are respectively located in the sub-sockets 137.

Specifically, the at least one spacing rib 136 includes two spacing ribs 136, and the plurality of sub-sockets 137 includes three sub-sockets 137 arranged along the second axis A2. As shown in FIG. 8, these metal bars 119 include three metal bars 119, and lengths L4-L6 of the three metal bars 119 on the second axis A2 respectively correspond to lengths L7-L9 of the three sub-sockets 137 on the second axis A2. Two of the three metal bars 119 on both sides contact the casing 120 to connect to a larger ground plane to improve impedance stability.

In the embodiment, a length L5 of a central one of the three metal bars 119 on the second axis A2 is less than lengths L4 and L6 of the other two of the three metal bars 119 on the second axis A2, but the invention is not limited thereto.

It should be noted that USB has been upgraded from 3.0 to 3.2, a new test specification Radio Frequency Interference (RFI) test has been added, and the main purpose of such test is to ensure that when the electronic device 10 has multiple adjacent USB connectors plugged in, they will not interfere with each other during transmission. Specifically, the RFI test of USB 3.2 is that when the USB connector is operating, the interference detected from other adjacent USB connectors must be lower than a certain value, a spectrum range of the tested signal is 0.5 GHz-6 GHz, and the value of interference should be lower than −100 dBm.

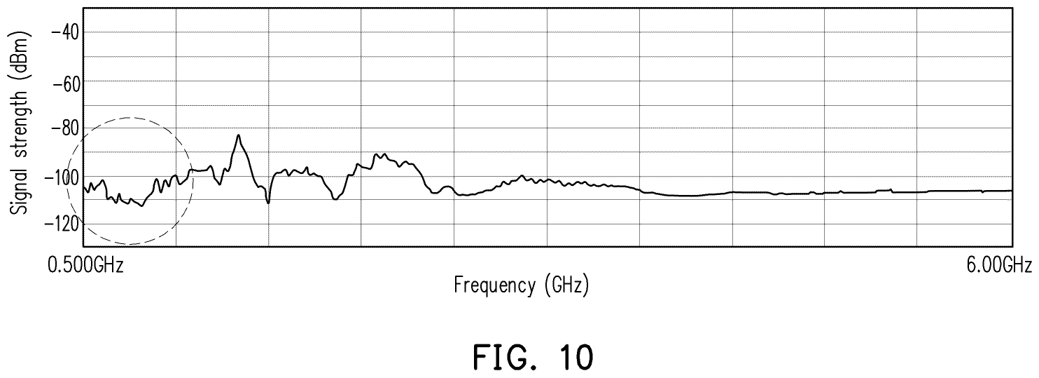

FIG. 9 is an RFI test result diagram of interference signal received by other adjacent connectors when a conventional USB 3.0 type B connector is in operation. Referring to FIG. 9, a ground plane of the conventional USB 3.0 type B connector is a metal casing, and since a distance between the metal casing and the terminals is long, it is unstable and likely to produce radiation.

Therefore, it may be seen from FIG. 9, when the conventional USB 3.0 type B connector is operating, the interference signal received by other adjacent connectors (taking a USB type C connector as an example, but the invention is not limited thereto) is in a dotted box, i.e., near a 0.5 GHz frequency band, and the received interference signal is higher than −100 dBm, and it failed the RFI test.

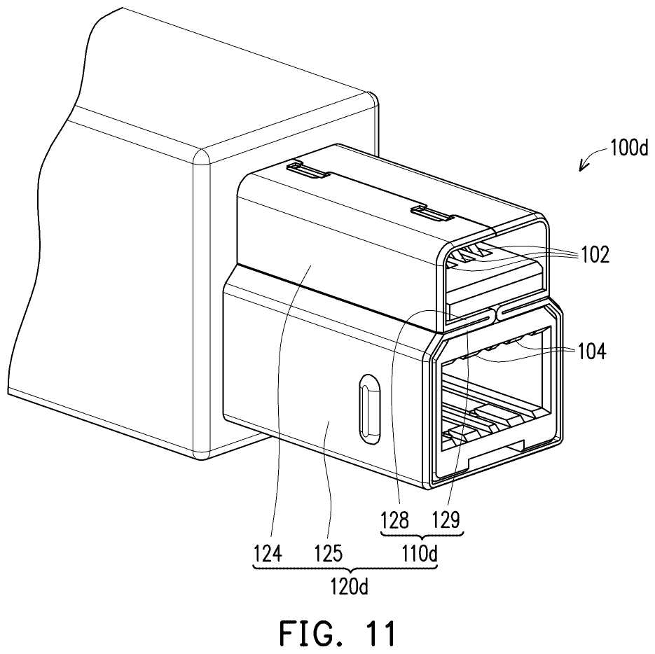

FIG. 10 is an RFI test result diagram of interference signal received by other adjacent connectors when the connector of FIG. 7 is in operation. Referring to FIG. 7 and FIG. 10, in the USB type B connector 100c of FIG. 7, a ground metal layer 110c located between the first terminals 102 and the second terminals 104 is added. Since the distance between the ground metal layer 110c and the first terminals 102 and the second terminals 104 is relatively close, such a design may make the circuit more stable and less likely to cause interference. Therefore, as shown in FIG. 10, when the USB type B connector 100c of FIG. 7 is operating, the interference signal received by other adjacent connectors is at the dotted box, i.e., close to the 0.5 GHz frequency band, and the received interference signal is lower than −100 dBm and may pass the RFI test. Therefore, the USB type B connector 100c in FIG. 7 may pass the USB 3.2 type B qualification certification.

Certainly, not only the USB type B connector 100c in FIG. 7, but also all USB type B connectors of the invention may have the above effect to pass the RFI test and has the USB 3.2 type B qualification certification due to that the ground metal layer 110 is provided between the first terminals 102 and the second terminals 104.

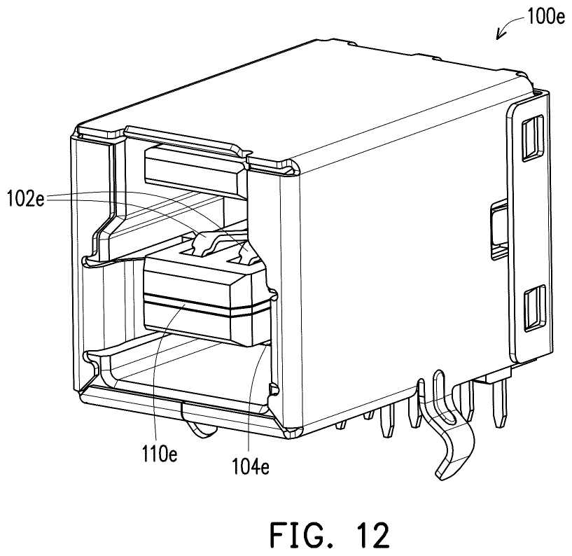

FIG. 11 is a schematic diagram of a connector according to another embodiment of the invention. Referring to FIG. 11, a main difference between a USB type B connector 100d of the embodiment and the USB type B connector 100 of FIG. 1 lies in the form of the ground metal layer 110d. In the embodiment, a casing 120d includes a ground metal layer 110d. The ground metal layer 110d includes a first layer 128 and a second layer 129 that are bent and folded. The first layer 128 is connected to the upper casing base 124, and the second layer 129 is connected to the lower casing base 125. The ground metal layer 110, the upper casing base 124, and the lower casing base 125 are integrated.

Namely, after fabrication of the casing 120d is completed, the ground metal layer 110d is formed, and the ground metal layer 110d does not need to be set on the casing 120d through additional assembly.

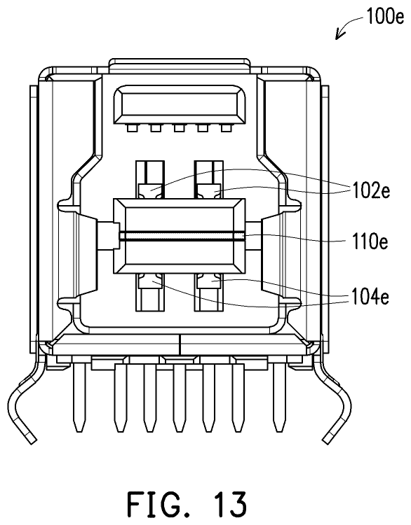

FIG. 12 to FIG. 13 are schematic diagrams of a connector from different perspectives according to another embodiment of the invention. Referring to FIG. 12 and FIG. 13, a main difference between a USB type B connector 100e of the embodiment and the USB type B connector 100 of FIG. 1 is that the USB type B connector 100 of FIG. 1 is a male connector, and the USB type B connector 100e of the embodiment is a female connector.

In the embodiment, the first terminals 102e are a middle row of terminals, the second terminals 104e are a bottom row of terminals, and the ground metal layer 110e is located between the middle row of terminals and the bottom row of terminals. Certainly, the types and positions of the first terminals 102e, the second terminals 104e and the ground metal layer 110e are not limited thereto.

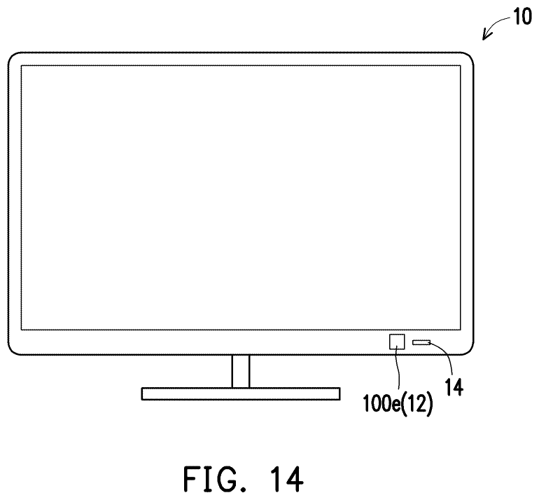

FIG. 14 is a schematic diagram of an electronic device according to an embodiment of the invention. Referring to FIG. 14, the electronic device 10 in the embodiment is, for example, a screen, but the type of the electronic device 10 is not limited thereto. The electronic device 10 includes a first connector 12 and a second connector 14 adjacent to each other. The first connector 12 is, for example, the USB type B connector 100e of FIG. 12.

The second connector 14 is located next to the first connector 12. The second connector 14 is, for example, a USB type C connector, but the invention is not limited thereto. In the embodiment, the second connector 14 is different from the first connector 12. Certainly, in other embodiments, the second connector 14 may also be the same as the first connector 12.

Since the first connector 12 has the design of a ground metal layer, it may have at least following two functions during signal transmission and reception. First, it brings the impedance matching back to an original control range to enhance resistance to external interference, thereby providing good signal stability. Second, it has a good shielding effect and reduces the impact on signal transmission and reception of other surrounding connectors. Therefore, when the first connector 12 is operating, the interference signal received by the adjacent second connector 14 may be quite small without affecting the operation of the second connector 14. Therefore, both of the first connector 12 and the second connector 14 may have good operating effects.

In summary, in the USB type B connector of the invention, the ground metal layer is disposed between the row of first terminals and the row of second terminals, and the length of the ground metal layer on the first axis along which the second terminals extend is greater than or equal to the length of each terminal of the row of first terminals on the first axis and the length of each terminal of the row of second terminals on the first axis. Such design may have at least the following two functions during signal transmission and reception, first, it brings the impedance matching back to an original control range to enhance resistance to external interference, thereby providing good signal stability, second, it has a good shielding effect and reduces impact on signal transmission and reception of other surrounding connectors.

What is claimed is:

1. A USB type B connector, comprising:
a row of first terminals;
a row of second terminals, located below the row of first terminals, wherein each terminal of the row of second terminals extends along a first axis; and
a ground metal layer, located between the row of first terminals and the row of second terminals, wherein a length of the ground metal layer on the first axis is greater than or equal to a length of each terminal of the row of first terminals on the first axis and a length of each terminal of the row of second terminals on the first axis.

2. The USB type B connector as claimed in claim 1, wherein projections of the row of first terminals and the row of second terminals on a plane where the ground metal layer is located are all within the ground metal layer.

3. The USB type B connector as claimed in claim 1, further comprising a casing and an insulating inner base located in the casing, wherein a first socket is located between a casing top surface of the casing and an inner base top surface of the insulating inner base, the insulating inner base comprises a second socket, the row of first terminals is located in the first socket, the row of second terminals is located in the second socket, and the ground metal layer is located between the first socket and the second socket.

4. The USB type B connector as claimed in claim 3, wherein the row of first terminals and the row of second terminals are arranged along a second axis, a material of the casing is a conductor, and the ground metal layer contacts the casing on the second axis.

5. The USB type B connector as claimed in claim 3, wherein the insulating inner base comprises an upper inner base and a lower inner base, the upper inner base comprises the inner base top surface, the lower inner base comprises the second socket, a third socket is located between the upper inner base and the lower inner base, and the ground metal layer is located in the third socket.

6. The USB type B connector as claimed in claim 5, wherein the ground metal layer is a rectangular metal sheet, and two opposite outer edges of the ground metal layer contact the casing.

7. The USB type B connector as claimed in claim 5, wherein the ground metal layer comprises a main body metal sheet and two extension parts extending from the main body metal sheet, and the two extension parts contact the casing.

8. The USB type B connector as claimed in claim 7, wherein the row of first terminals and the row of second terminals are arranged along a second axis, the main body metal sheet comprises a first part and a second part, the two extension parts are two elastic arms that contact an inner surface of the casing, the two elastic arms are located on two sides of the first part, and a distance between two outer edges of the two elastic arms on the second axis is greater than a length of the second part on the second axis.

9. The USB type B connector as claimed in claim 8, wherein each of the two elastic arms comprises a fixed end away from the second part and a free end close to the second part, and there is a gap between the free end and the first part.

10. The USB type B connector as claimed in claim 7, wherein the two extension parts contact an outer surface of the casing.

11. The USB type B connector as claimed in claim 5, wherein the insulating inner base comprises at least one spacing rib located in the third socket, the at least one spacing rib divides the third socket into a plurality of sub-sockets, the ground metal layer comprises a plurality of metal bars connected with each other, and the metal bars are respectively located in the sub-sockets.

12. The USB type B connector as claimed in claim 11, wherein the row of first terminals and the row of second terminals are arranged along a second axis, the at least one spacing rib comprises two spacing ribs, the plurality of sub-sockets comprise three sub-sockets arranged along the second axis, the metal bars comprise three metal bars, and lengths of the three metal bars on the second axis respectively correspond to lengths of the three sub-sockets on the second axis.

13. The USB type B connector as claimed in claim 12, wherein the length of a central one of the three metal bars on the second axis is less than the length of any of the other two of the three metal bars on the second axis.

14. The USB type B connector as claimed in claim 12, wherein two of the three metal bars located on two sides contact the casing.

15. The USB type B connector as claimed in claim 3, wherein the insulating inner base comprises an upper inner base and a lower inner base, the upper inner base comprises the inner base top surface, the lower inner base comprises the second socket, the casing is made of metal, the casing comprises the ground metal layer and a first cavity and a second cavity separated by the ground metal layer, the upper inner base is located in the first cavity, and the lower inner base is located in the second cavity.

16. The USB type B connector as claimed in claim 15, wherein the casing comprises an upper casing base and a lower casing base, the ground metal layer comprises a first layer and a second layer that are bent and folded, the first layer is connected to the upper casing base, the second layer is connected to the lower casing base, and the ground metal layer, the upper casing base, and the lower casing base are integrated.

17. A transmission line, comprising:
a wire; and
the USB type B connector as claimed in claim 1, connected to the wire.

18. The transmission line as claimed in claim 17, wherein the ground metal layer is electrically connected to the wire.

19. An electronic device, comprising:
a first connector, being the USB type B connector as claimed in claim 1; and
a second connector, located next to the first connector.

20. The electronic device as claimed in claim 19, wherein the second connector is different from the first connector, or the second connector is the same as the first connector.
